(19) United States
(12) Patent Application Publication
(10) Pub. No.: US 2002/0000150 A1
(43) Pub. Date: Jan. 3, 2002

(54) TREE FELLING DISC SAW TEETH WITH WEAR-RESISTANT INSERTS

(76) Inventors: JOHN KURELEK, ONTARIO (CA); ANDREW ROBERT HOSHEL, ONTARIO (CA)

Correspondence Address: BORDEN LADNER GERVAIS, LLP, 1000 - 60 QUEEN STREET, OTTAWA, ON, K1P 5Y7, CA

(21) Appl. No.: 09/414,485

(22) Filed: Oct. 8, 1999

(51) Int. Cl. B27B 13/02

(52) U.S. Cl. 83/835; 83/839; 83/840

(57) ABSTRACT

Saw teeth, particularly for tree harvesting, have a wear-resistant insert or inserts of tungsten carbide, for example, oriented along the side and/or outer surface of the saw tooth, extending rearwardly from the leading edges, instead of being along the impact face as is conventional. As wear occurs, sharpness is retained longer and less material needs to be removed once sharpening is required. The principle may be adapted to a wide variety of saw tooth configurations.

### BACKGROUND OF THE INVENTION

This invention relates generally to the teeth used on a disc saw blade of the type used for tree harvesting, especially but not necessarily limited to tree felling with a feller buncher. These machines are well known in the industry and typically feature a horizontal saw disc, which is rotated about a generally vertical axis and fed through a tree by the forward travel of the machine or the reach of a boom. Although the invention is primarily intended for tree felling, it could conceivably be for tree harvesting in general, i.e. including saws for mulching, brush-clearing, slashing, etc..

Saw blades used on such machines typically consist of a mounting hub, a web portion and a thick outer rim with teeth mounted around its periphery. Alternatively, the blade has also been made out of a thinner, flat steel plate with tooth holders along the outer rim to reduce machining costs. These blades must cut a relatively wide kerf to accommodate the special demands of the tree felling operation. Trees must be supported by a butt plate after they are severed, to prevent further contact with the rotating blade. This plate must fit at least partially into the kerf. Also, the forward motion of the blade into the tree is not very well controlled by a feller buncher, so the blade must be strong to resist bending when the head changes feed direction part way through the cut. As a result of the wide kerf, tree felling removes more material as waste and requires more power than other wood cutting operations.

The teeth used on such blades have evolved from simple tips integral to the blade which were alternately bent up and down, similar to some inexpensive cross-cut saws, to the replaceable teeth most common today. There are too many types of replaceable teeth on the market today to list here, but they all rely on the fact that a replaceable tooth is more likely to be serviced than one that is an integral part of the blade. It is important that the teeth be kept sharp because a sharp cutting edge provides benefits beyond better productivity and reduced fuel consumption. Sharp teeth reduce the cutting forces, thereby reducing stress on the blade, prolonging its life. They also provide a smoother tree butt, which is important for sawmilling operations.

Saw teeth can generally be divided into two categories: carbide and non-carbide. Carbide teeth have at least one wear-resistant insert, usually of tungsten carbide and usually installed by brazing, for use in conditions where contact with rocks is an unlikely occurrence. These inserts greatly extend the useful life of the teeth by maintaining a sharp edge longer than teeth with hardened steel cutting edges, due to the higher wear resistance of the carbide inserts. The carbide inserts also tend to protect the body of the tooth, which is generally made out of steel, from wear by preventing contact between the tooth body and the wood or soil that is rubbing the tooth.

Such carbide inserts are typically fastened to the body of the tooth by methods known to the art, usually by brazing. Although inserts are sometimes fastened to their holders with threaded fasteners or rivets in the machining industry, these methods are not in common use for woodcutting teeth due to the extreme stresses and wear patterns common in this industry.

In conditions where rock contact is a regular occurrence, teeth with hardened steel cutting edges are common because of the ability of these teeth to deform where a carbide insert might shatter. Even a damaged steel tooth cuts better than a carbide tooth when one of its inserts has been shattered. In rocky soil conditions, the blade is usually kept farther off the ground, reducing wear due to erosion by the soil, thus extending the life of the teeth.

With current art carbide-tipped teeth, tooth life is greatly improved over that of non-carbide teeth. However, the portion of total tooth life in which the tooth cuts efficiently is somewhat less than ideal.

Current-design carbide feller buncher saw teeth typically have the carbide insert mounted on the impact faces of the teeth, as seen in FIG. 14 (prior art) such that there is very little thickness in the direction of cut. This arrangement gives excellent resistance to wear caused by the flow of wood chips and other abrasive materials along the front face of the tooth, but, as the carbide insert wears, the cutting efficiency suffers. From field experience, it is known that as the cutting edge wears, it becomes rounded. The radius of this edge increases with further wear until the radius reaches the back of the carbide insert, as shown in FIG. 15 (prior art). At this point, the insert has been worn through its entire thickness along the cutting edge and any further wear will now be in a radial direction relative to the blade, i.e. towards the center of the blade, which will reduce the depth of cut correspondingly. Particularly but not only with the C-shaped teeth of the preferred embodiment as described below, depth of cut is critical to the cutting performance of the blade, because the smooth outer rim restricts the depth of cut to that portion of the cutting edge that lies outside the diameter of the rim. Cutting efficiency also suffers because the rounded edge no longer cuts the wood fibers with a shearing action. Instead, it tends to tear them out as the tooth forces its way through the tree, consuming much more energy and producing a much rougher, uneven tree butt as it does so. Minimizing the cutting edge radius would reduce these effects.

As the insert wears inwardly, i.e. towards the center of the blade, the parent material behind the insert wears as well because it is much softer than the insert. The tooth eventually acquires a greatly reduced depth of cut. Although the tooth will continue to cut, however poorly, its useful life should be considered over when cutting efficiency suffers noticeably. This can be determined by the condition of the tree butts or the rate of speed reduction in the blade during a cut. At this point, the teeth should either be sharpened or replaced.

This problem could be reduced somewhat by the use of a thicker carbide insert, but that would only allow the radius to eventually become that much larger, resulting in even worse cutting efficiency with dull teeth.

A further disadvantage of this carbide orientation comes when sharpening teeth. In order to sharpen a tooth, a good deal of material needs to be removed during sharpening in order to get rid of the rounding, and that material removal comes primarily at the expense of the cutting depth, which is highly undesirable.

There is therefore a need for an improved wear-resistant insert configuration, to provide not only a long life for the teeth, but also efficient cutting for a longer portion of that life.

### SUMMARY OF THE INVENTION

This invention therefore provides a tree felling disc saw having teeth with a wear-resistant insert or inserts configured and installed in such a way as to maintain a sharp cutting edge longer than current designs.

For convenience, these wear-resistant inserts will be referred to as being of tungsten carbide, or simply “carbide”, but it should be understood that the invention resides in the configuration of the wear-resistant inserts, not on them being of tungsten carbide necessarily. The invention could involve the use of any hard material which is more resistant to wear than the material of the tooth. All references herein to “carbide” are thus merely for convenience and as one example.

In the invention, the carbide inserts are oriented along the side and/or outer surface of the saw tooth, extending rearwardly from the leading edges, instead of being along the impact face, i.e. a face generally perpendicular to the direction of rotation. That is, the length of the inserts is substantially greater than the thickness of the inserts, preferably by a ratio of about 2:1 or more. This configuration provides several significant advantages, as explained in detail later herein.

Throughout the following description and in the accompanying claims, bearing in mind that the disc saw blade is normally horizontal during use, all directional references shall be in relation to that normal operating position, and to the normal direction of rotation of the blade. Thus the disc will be referred to as having an upper surface and a lower surface, and the teeth correspondingly as having upper and lower or top and bottom surfaces. The “tail” of each tooth is “forward” of the head of the tooth which has an “outer” circumferential surface, and a “front”-facing or “forward”-facing radial impact surface or face. “Inner” or “inward” means towards the center of the disc. The leading edges or wear edges of the tooth are the forward-most edges of the tooth, i.e. the points where the tooth first impacts the tree.

### BRIEF DESCRIPTION OF THE DRAWINGS

The invention will now be described in greater detail, with reference to the accompanying drawings of preferred and alternative embodiments, in which:

FIG. 1 is a plan view of the preferred embodiment of the disc saw blade;

FIG. 2 is a plan view of a portion of the disc saw blade and several teeth;

FIG. 3 is a perspective view of the presently-preferred embodiment of one of the teeth, with upper, lower and outer inserts, and the outer insert butted between the upper and lower inserts;

FIG. 4 is a perspective view of the FIG. 3 tooth, from a reverse angle;

FIG. 4A is an exploded perspective view corresponding to FIG. 4;

FIG. 5 is a perspective view of a first alternative embodiment of one of the teeth, with upper, lower and outer inserts, and the upper and lower inserts butted against outer insert;

FIG. 6 is a perspective view of the FIG. 5 tooth, from a reverse angle;

FIG. 7 is a perspective view of a second alternative embodiment of one of the teeth, with upper and lower inserts only;

FIG. 8 is a perspective view of the FIG. 7 tooth, from a reverse angle;

FIG. 9 is a perspective view of a third alternative embodiment of one of the teeth, with an outer insert only;

FIG. 10 is a perspective view of the FIG. 9 tooth, from a reverse angle;

FIG. 11 is a perspective view corresponding to FIG. 6, but showing an alternative (straight) profile for the outer carbide insert;

FIG. 12 is a perspective view of a “handed” tooth;

FIG. 13 is a side view of the FIG. 12 tooth;

FIG. 14 (prior art) is a top view of a tooth with a carbide insert on the face of the tooth, as is typical in the prior art;

FIG. 15 (prior art) is a top view of the FIG. 14 tooth, worn;

FIG. 16 (prior art) is a top view of the FIGS. 14-15 tooth, after sharpening;

FIG. 17 is a top view showing partial wear on a tooth of the FIGS. 9-10 type according to the invention;

FIG. 18 is a top view showing a new FIGS. 9-10 type tooth;

FIG. 19 is a top view showing wear on the FIG. 18 tooth;

FIG. 20 is a top view showing extreme wear on the FIG. 18 tooth;

FIG. 21 shows the limited material removal required to sharpen a worn tooth;

FIG. 22 is a perspective view of a different type of tooth, modified according to the invention to receive the inserts of the invention, but without those inserts in place;

FIG. 23 is a side view of the FIG. 22 tooth;

FIG. 24 is an end-on view of the FIG. 22 tooth;

FIG. 25 is a top view of the FIG. 22 tooth;

FIG. 26 is a cross-sectional side view of the FIG. 22 tooth;

FIG. 27 is a cross-sectional top view of the FIG. 22 tooth;

FIG. 28 is perspective view of the FIG. 22 tooth, with the inserts in place;

FIG. 29 is a side view of the FIG. 28 tooth;

FIG. 30 is a top view of the FIG. 28 tooth;

FIG. 31 is a top view showing a typical installation of the tooth of FIGS. 22-30; and

FIG. 32 is a side view corresponding to FIG. 31.

### DETAILED DESCRIPTION

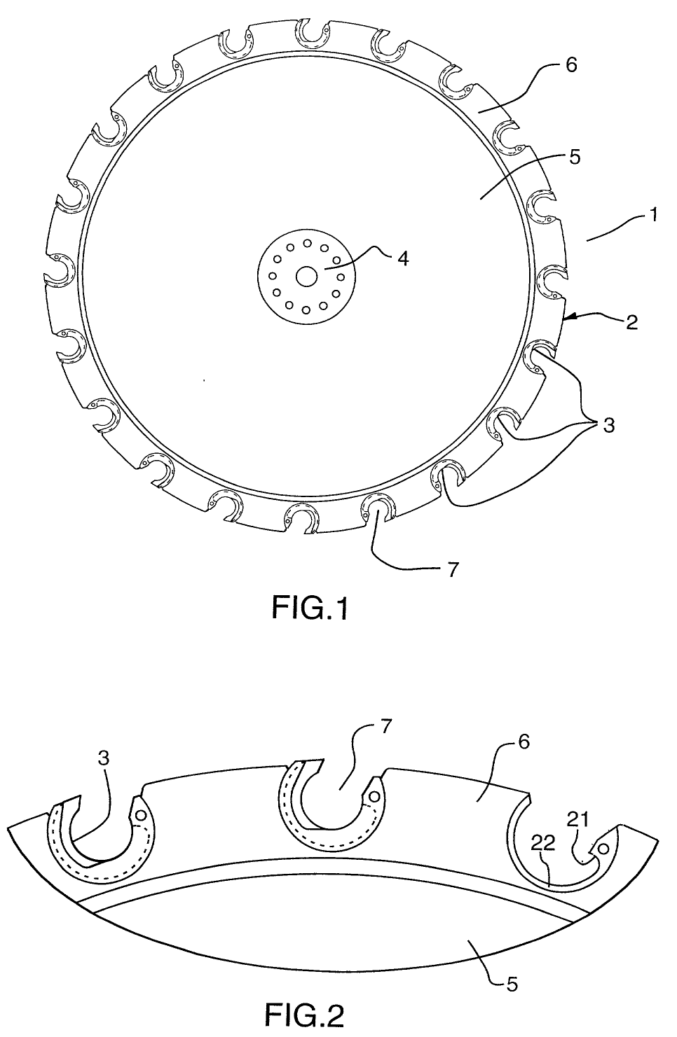

FIG. 1 shows a disc saw blade 1 comprising a disc 2 and a number of removable teeth 3. The disc has an integral hub 4, web portion 5, and rim portion 6. In the preferred embodiment, the teeth are arcuate, i.e. generally C-shaped, with an open gullet 7, and are installed in correspondingly-shaped sockets in the rim portion 6. Each tooth has a tail end and a cutting end, preferably with a wide kerf (at least for tree-felling applications). the cutting end having a cutting edge projecting slightly from the circumference of the blade. A portion of the tooth, for example a tail stop 20, butts against stop means associated with the disc saw blade, for example a tail stop 21 as shown in FIG. 2, to prevent rotation of the cutting edge in a direction inwardly from the circumference of the blade. The stop means thus absorbs rotational forces transmitted from the cutting edge during cutting. The teeth are installed by rotating them onto a male key portion 22, for example, the tooth having a corresponding female circumferential groove, into position against the tail stop.

The hub 4 is a-mounting means for bolting the blade to conventional drive means (not shown). In normal operation, the disc is generally horizontal, and as mentioned above, all references to directions herein will be with respect to this normal orientation during operation.

FIG. 2 is a close-up view of a portion of the blade and several teeth of the preferred embodiment.

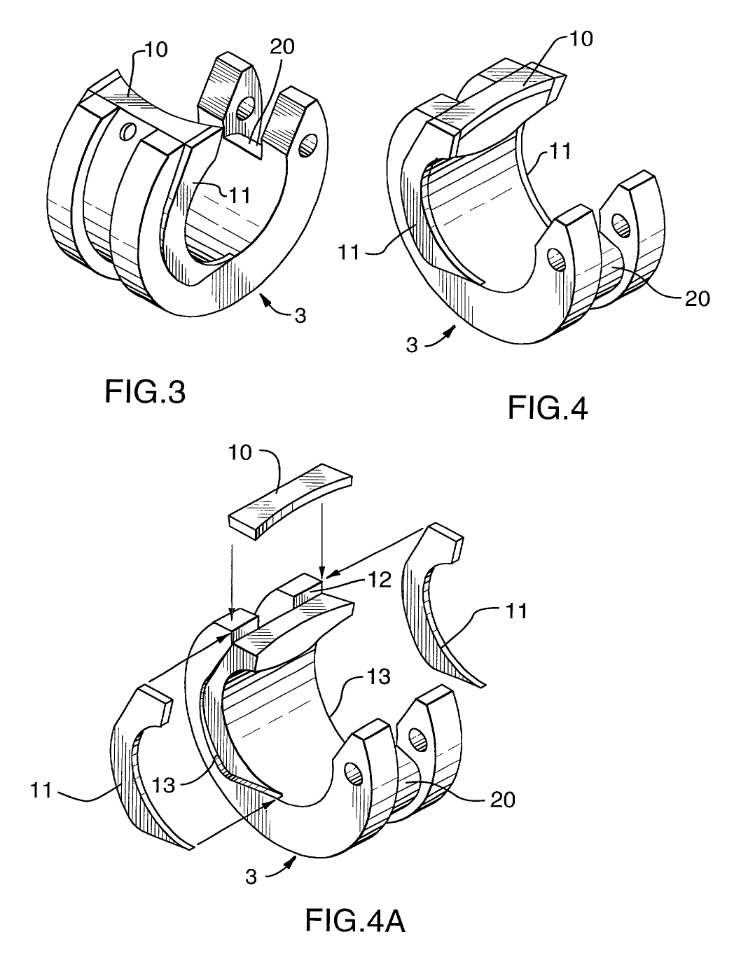

As seen more clearly in FIGS. 3-6, each tooth in the preferred embodiment and first alternative embodiment of the invention has an outer carbide insert 10 and upper and lower carbide inserts 11. The carbide inserts constitute the outer and upper and lower leading edges of the teeth, i.e. the first portions to come into contact with the tree, and remain as such as the teeth wear, since the softer steel or other material adjacent to the inserts will wear more quickly than the inserts themselves.

The outer insert 10 extends rearwardly from the outer leading edge, along the outer surface of the tooth, protecting a significant portion of this outer surface from wear. It is brazed or otherwise secured along the outer surface of the tooth, with a rear face of the insert preferably but not necessarily butting against a face defined by the back of a notch 12, as seen best in FIG. 4A.

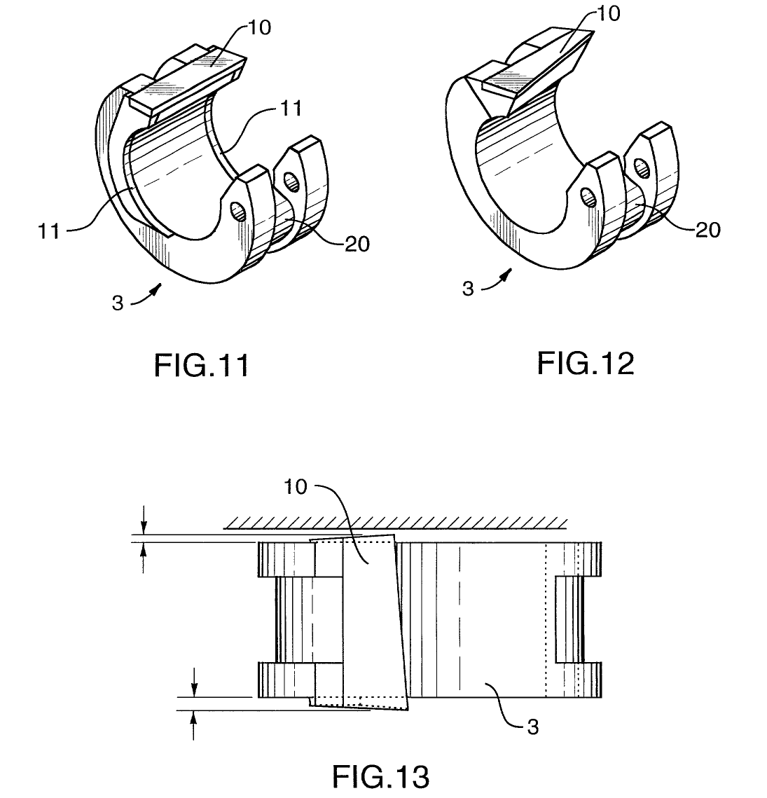

In the preferred embodiment, as shown in FIGS. 3, 4 and 4A, the upper and lower inserts 11 provide the upper and lower outer corners of the tooth, and thus they do most of the cutting, those corners being the first points to impact the tree. Thus although they could be brazed onto the upper and lower surfaces of the tooth as shown in FIG. 11, preferably they are also supported somewhat by virtue of being located in a tapered recess 13 along the upper and lower surfaces of the tooth, as best seen in FIG. 4A, such that the outer part of the insert juts out from the upper and lower surfaces of the tooth, whereas the inner part of the insert is basically flush with the upper and lower surfaces of the tooth. This tapering has the added advantage of providing some clearance in the kerf for passage of the rest of the tooth, so as to minimize friction or binding. Alternatively, the upper and lower inserts could be entirely flush with the upper and lower surfaces of the tooth, by virtue of an untapered recess, but that is not preferred.

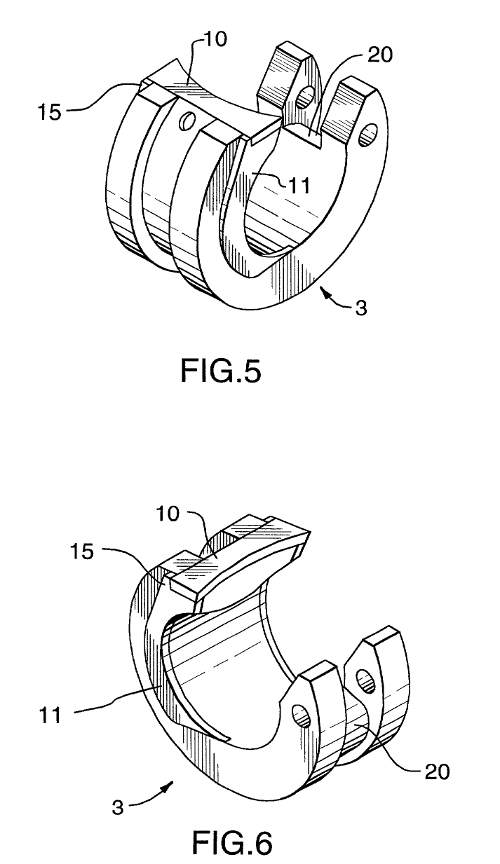

FIGS. 5 and 6 show a first alternative embodiment, in which the outer insert 10 is intended to do the cutting. In this embodiment, as well as in the preferred embodiment but to a slightly lesser degree, it is preferable that the outer insert should be well supported, e.g. in a notch 12. Preferably, the upper and lower inserts each have a small tongue portion 15 which extends behind the outer insert, so as to prevent a path from gradually being worn through between the inserts. In this embodiment, the upper and lower carbide inserts 11 still preferably are in a tapered recess 13, for the above-mentioned clearance reason, but support against impact is slightly less important.

Instead of the carbides being butted against each other, either as in FIGS. 3 and 4 or as in FIGS. 5 and 6, of course they could join at 45 degrees or some other angle, or could simply come to approximately the same corner areas without actually butting together, although this would be less preferable.

Of course, if the brazing of the inserts was carried out perfectly, then no notches would be required at all. However, since one cannot be absolutely certain that 100% of the brazes will be perfect, it is preferable to provide the notches or recesses for added security. The notches or recesses also simplify the manufacturing process, by providing a seat or home location for the inserts.

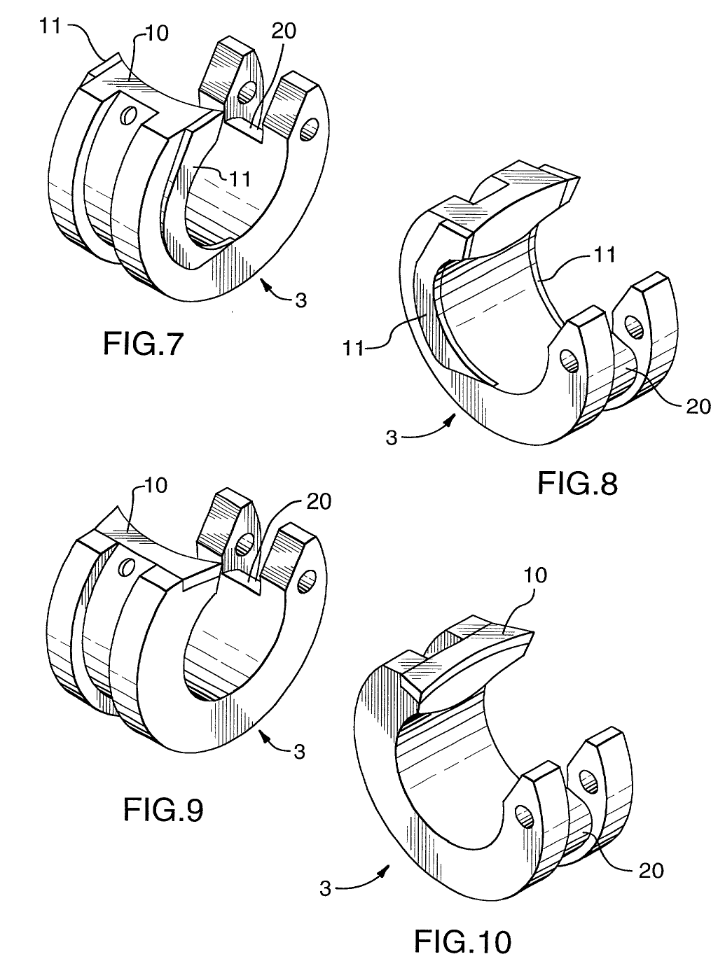

Preferably all three carbide inserts are present, but teeth could be adopted which only had the upper and lower carbides 11, as shown in FIGS. 7 and 8, or which only had the outer carbide 10, as shown in FIGS. 9 and 10. If the teeth have just upper and lower carbide inserts 11 without outer carbide inserts 10, then those inserts become the leading edges or impact surfaces as the parent material wears away.

Having just the outer carbide insert 10 is certainly advantageous over the prior art. Having the upper and lower carbide inserts 11 as well further improves the cutting efficiency by ensuring that excessive wear does not occur to the parent tooth material beneath the outer carbide insert, such as to lead to a large-radius rounded edge. Such a rounded edge would cause tearing of the wood fibers that have been separated by the outer carbide insert when the wood chips are being removed.

The outer insert 10 can be made in a variety of profiles. For example, it could have a straight leading edge as shown in FIG. 11. However, preferably, it is curved so as to be concave, as illustrated in FIGS. 3-10. The curvature provides relief in the cut for advancement of the blade, and produces a shearing action which consumes less energy and reduces impact loading on the carbon inserts. Also, because the edges of the blade tend to wear more rapidly than the middle, it is preferable to start with the concave curvature and wear towards flat, than to start from flat and wear towards convex (where the middle of the cutting edge would contact the tree first, which would not be desirable. Similarly, V-shaped would also be possible, but is less desirable due to stress concentration at the middle of the V. Either concave or V-shaped will keep the cutting tips closer to the edges of the tooth for a longer time.

Another variation, as shown in FIGS. 12 and 13, is a “handed” tooth, i.e. a “left” and a “right”. This tooth would have a preferably but not necessarily angled outer insert 10 and/or just one upper or lower insert 11. Left and right teeth would be alternated around the circumference of the blade, so that one tooth cuts the upper edge of the kerf, and the next tooth cuts the lower edge of the kerf. The principle of the invention is the same in any event, i.e. at least one carbide insert with its long dimension extending rearwardly from a leading edge.

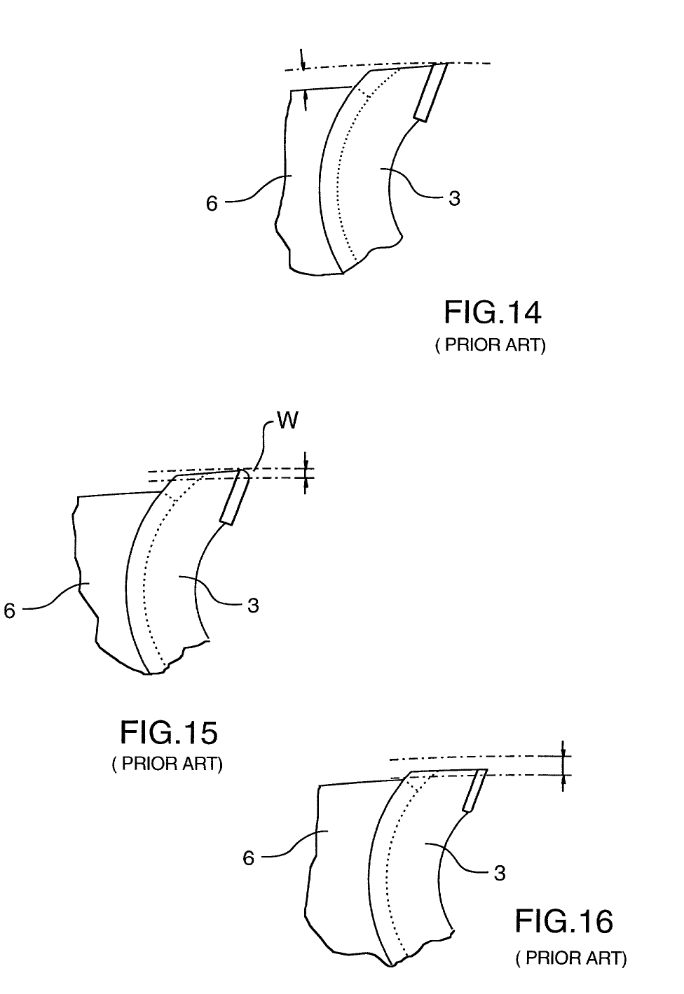

A particular advantage of the invention is that the cutting edges stay sharper for longer than in the prior art. FIG. 14 (prior art) shows a new prior art tooth, with a carbide insert on its impact face. The dimension arrows show the cutting depth, or bite per tooth. FIG. 15 (prior art) shows that as that tooth becomes worn, a wear radius W develops. The dimension arrows show that the leading point, the point that contacts the tree first, migrates inwards as the radius W increases. That radius will keep increasing as the wear continues, making the cut less and less efficient. The radius stops increasing when the wear reaches the back of the insert. At this point, the leading point of the radius then begins to migrate towards the center of the blade, reducing the depth of cut.

FIG. 16 (prior art) shows that in order to restore full or nearly full sharpness, material must be removed beyond the leading point from the outside face. This significantly reduces the depth of cut, as seen by comparing to the dimension arrows, which show the original cutting depth of the tooth.

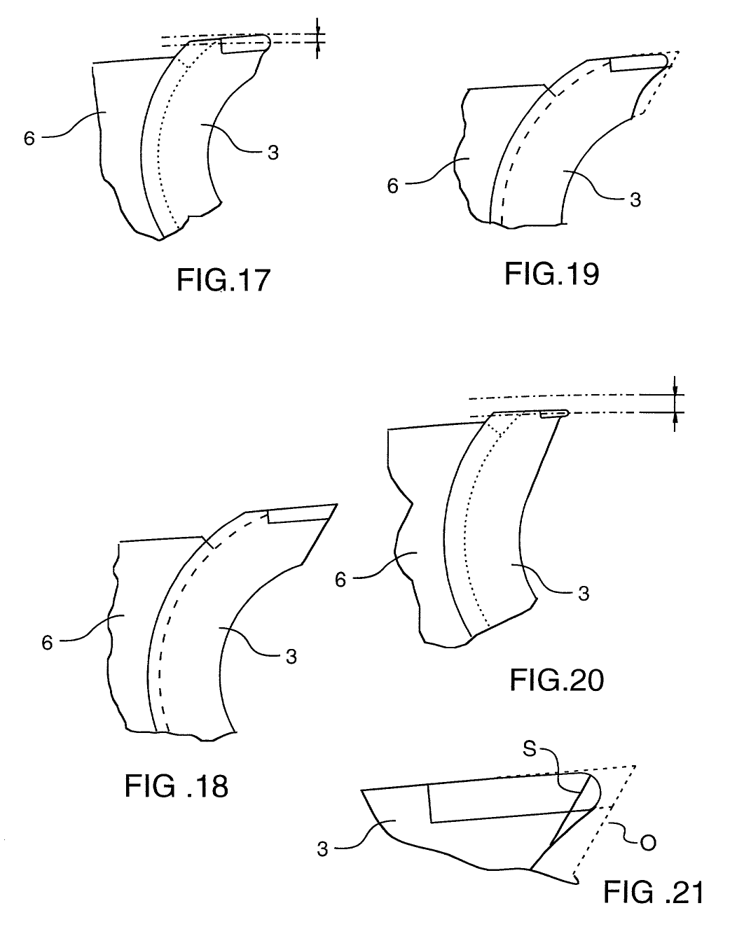

In the invention, as illustrated by FIGS. 17-21, the situation is different. The wear radius that is formed on the cutting edges can only be a maximum of roughly half the thickness of the insert. This is due to the fact that the insert will wear on its outside and inside edges because the softer parent tooth material offers very little resistance to wear. This is shown in FIG. 17. Once again, the dimension arrows show the distance from the original cutting depth to the leading point after some wear has occurred. However, once the wear pattern as shown in FIG. 17 has been reached, any further wear will be in a direction rearward, parallel to the direction of cut. The depth of cut does not significantly decrease with further wear. This results in a relatively small, self-sustaining radius on the leading edge of the tooth that provides higher cutting efficiency for a greater portion of the tooth life. Compare also FIG. 18, a new tooth, to a worn tooth, as in FIG. 19.

Because the radius on the tooth cutting edge stays relatively small, the tooth will cut and separate the wood fibers more efficiently. In fact, as the tooth wears further, more material will be removed from the outer surface of the carbide, making it thinner. The thinner carbide will now have an even smaller edge radius that has migrated only slightly towards the center of the blade. Thus, the insert becomes effectively sharper the more it wears, as can be seen in FIG. 20.

FIG. 21 illustrates that in sharpening a tooth, very little material needs to be removed, and most of it is from the face area rather than from the outer surface. Thus not only does the tooth not become as dull, but also it can be sharpened with possibly as little as 1/10 the material removal and ⅕ the bite loss, as can be appreciated from an examination of FIG. 21, in which the dotted line O indicates the original tooth shape. Removing material back to the solid line S is all that is required to restore full or nearly full sharpness.

Because the length portion of the carbide inserts of the invention extend rearwardly, as opposed to the thickness portion extending rearwardly, the depth of cut changes less as the tooth wears. This is a particularly important advantage of the invention for the preferred type of tooth, i.e. an arcuate tooth, since depth of cut is critical to cutting performance because the smooth outer rim restricts the depth of cut to that portion of the cutting edge that lies outside the diameter of the rim. Minimizing the wear rate in the radially inward direction means that for a given tooth life, a smaller initial exposure can be adopted.

A smaller initial exposure is extremely desirable. As explained in somewhat greater detail in a co-pending application relating to the C-shaped tooth itself, an undesirably large “throw gap” results from typical prior art shank and bolt tooth attachment methods. It is known that a tangentially oriented wooden stick, somehow accidentally and rapidly fed at the saw rim of teeth, can be dangerously thrown if a radial face of a moving saw tooth can contact sufficient of the stick end grain area to instantly accelerate it to tooth tip velocity without cutting or fracturing out a relatively harmless chip of wood. The exact values of such numbers as saw rpm, tooth velocity, stick size, stick density and weight and the engagement area at which throwing rather than cutting occurs are virtually impossible to calculate and design against. However, it is reasonable to predict that for any given saw speed, the greater the gap between the face of a tooth and the back of the previous passing tooth, the more likely it is that a stick end will occasionally enter the gap sufficiently to be thrown. A stick might enter a gap from either the upper or the lower or the circumference of a saw toothed rim. It is also evident that near horizontal or tangential stick angles would most likely result in a spear-like throw if the saw does not break a chip out of the stick. A continuous smooth rim which would not be able to throw cannot be used because at least enough gap needs to be provided as a gullet to accept the wood chips being cut loose and to carry them out of the cut for expulsion.

Therefore enabling a smaller initial exposure is extremely desirable in that it minimizes the throw gap. A small exposure or engagement means that the tooth tends to take a harmless chip out of a stick, without accelerating the stick, whereas a larger engagement can provide enough end grain in compression to transmit sufficient acceleration force to the stick to accelerate it.

This invention offers the additional advantage of providing a definite indicator of when the teeth need to be replaced. The outer carbide insert 10 lies completely outside the diameter of the outer rim of the saw blade. Therefore, the tooth will cut wood as long as some carbide material remains on the surface, and should no longer be used once the entire insert has worn away. The carbide thickness can be varied to determine the depth of cut at which teeth should be replaced. With prior art carbide inserts, there is no such indication, so teeth can wind up being used until they wear down to the outer rim, even though cutting efficiency is very poor and more friction occurs as the cutting depth approaches the outer rim. This leads to very inefficient cutting and burning of the wood during the later stages of the life of these teeth.

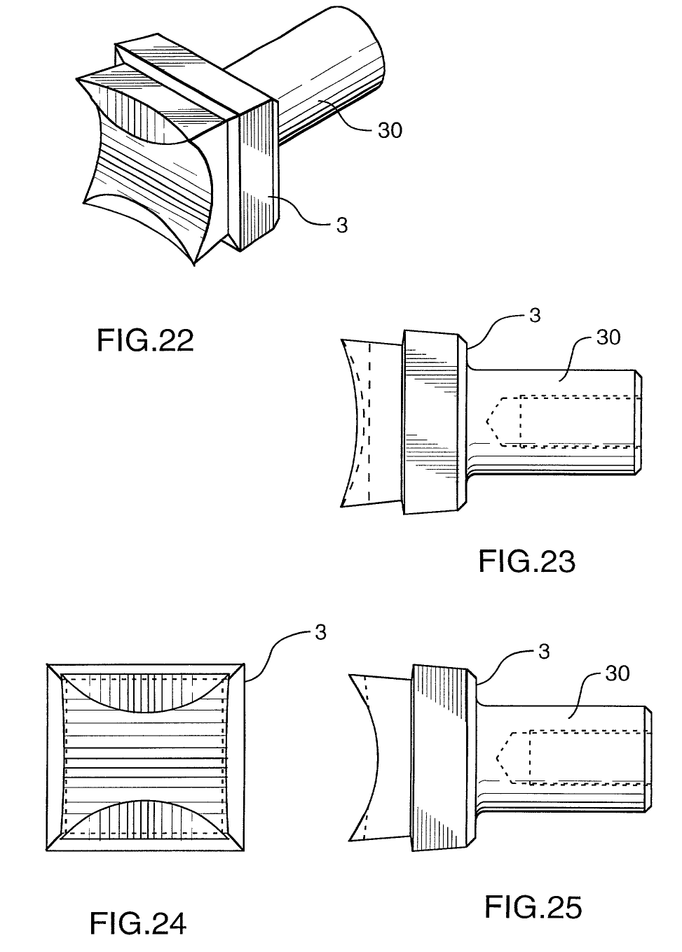

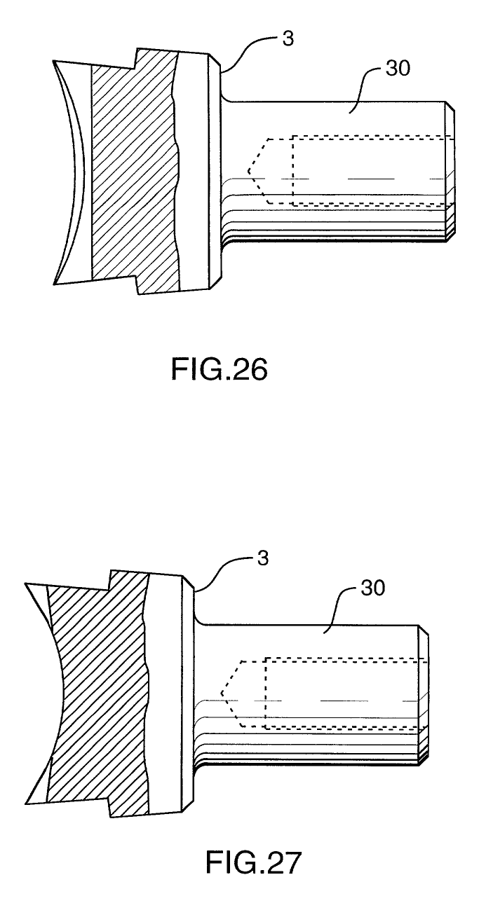

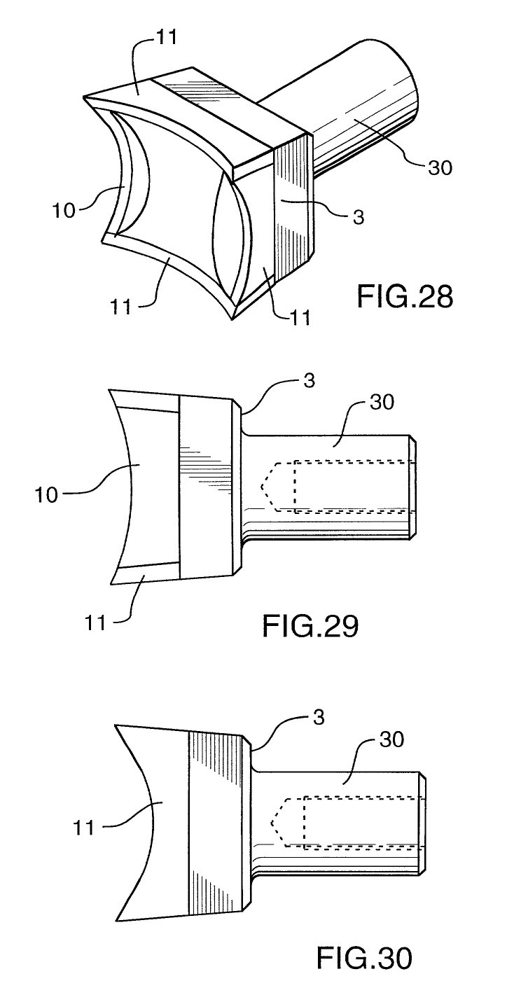

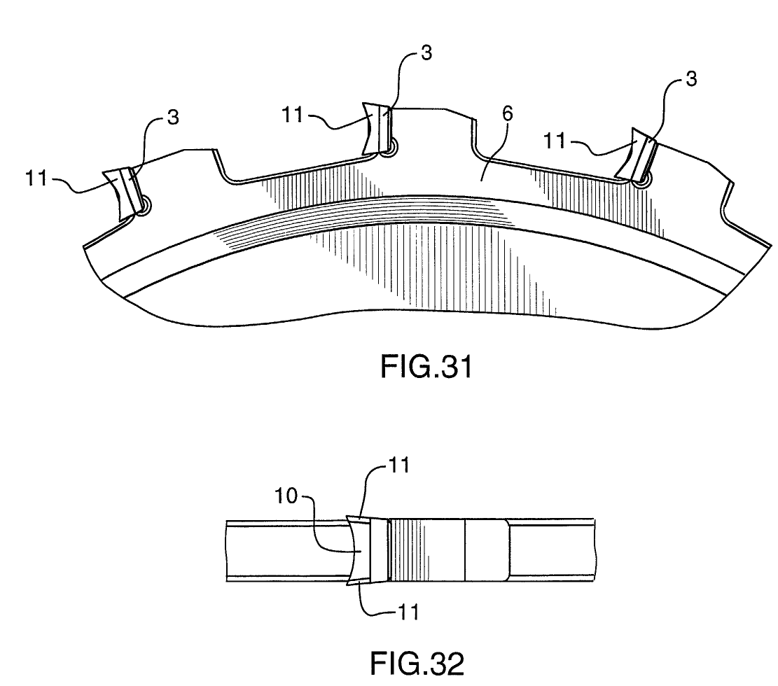

The preceding description relates to the invention as it pertains to the preferred C-shaped tooth. However, clearly this concept could be applied equally other tooth styles; the invention is not limited to the preferred C-shaped tooth. Another embodiment, for example, is shown in FIGS. 22-32. As known in the prior art, teeth of this general type are installed in a blade by virtue of the extended shank 30 fitting into a hole drilled in a projection from the blade, and are bolted in place, the shank having a threaded hole for that purpose. FIGS. 22-27 are various views of the tooth, ready to receive the inserts, and FIGS. 28-30 are various views with the inserts in place. FIGS. 31 and 32 shown the teeth installed on a blade. As in the preferred embodiment, each tooth 3 has an outer insert 10 and upper and lower inserts 11, but in fact there are two “outer” inserts 10, such that the tooth could be reversed after one outer insert becomes excessively worn, by rotating it 180 degrees about its axis.

As illustrated by the embodiment of FIGS. 22-32, it should be clearly understood that variations are possible within the scope of the invention as described above. The precise dimensions of the carbide insert obviously could vary. What is essential to the invention is not the precise dimensions, but the general configuration and positioning of the inserts, extending rearwardly from a leading edge area.

As just one more possible variation, for example, upper, lower and outer inserts could be provided not by having three separate pieces, but by having two generally L-shaped pieces meeting halfway down the tooth. Other complementary shapes obviously could be adopted as well, if preferred for some reason, while still embodying the inventive principle relating to the general position and orientation of the inserts.

What is claimed as the invention is:

1. A tooth for installation in a disc saw blade, said tooth comprising a body having a cutting edge projecting slightly from the circumference of said disc saw blade when said tooth is installed, said tooth having at least one wear-resistant insert having a length extending rearwardly along said tooth from a leading edge thereof, said length being at least about twice the thickness of said insert, said insert being of a material which is substantially harder and more wear-resistant than adjacent material of the tooth.

2. A tooth as recited in claim 1, comprising at least two said wear-resistant inserts, extending respectively along portions of upper and lower surfaces of said tooth.

3. A tooth as recited in claim 1, comprising a said wear-resistant insert extending across the thickness of the tooth on a radially outer surface thereof.

4. A tooth as recited in claim 1, comprising a said wear-resistant insert extending across the thickness of the tooth on a radially outer surface thereof, and two said wear-resistant inserts, extending respectively along upper and lower outer surfaces of said tooth.

5. A tooth as recited in claim 3, wherein said wear-resistant insert is curved, upper and lower leading edge portions thereof being ahead of a central leading edge portion.

6. A tooth as recited in claim 4, wherein said wear-resistant insert extending across the thickness of the tooth is curved, upper and lower leading edge portions thereof being ahead of a central leading edge portion.

7. A tooth as recited in claim 1, for installation in one of a plurality of arcuate sockets around the circumference of said disc saw blade, wherein said tooth comprises an arcuate body having a tail end and a cutting end, said cutting end having a cutting edge projecting slightly from the circumference of said disc saw blade when said tooth is installed in a said arcuate socket, each said tooth when installed having a portion thereof butting against stop means associated with said disc saw blade to prevent rotation of said cutting edge in a direction inwardly from said circumference of said disc saw blade, said stop means thereby absorbing rotational forces transmitted from said cutting edge during cutting.

8. A tooth as recited in claim 2, for installation in one of a plurality of arcuate sockets around the circumference of said disc saw blade, wherein said tooth comprises an arcuate body having a tail end and a cutting end, said cutting end having a cutting edge projecting slightly from the circumference of said disc saw blade when said tooth is installed in a said arcuate socket, each said tooth when installed having a portion thereof butting against stop means associated with said disc saw blade to prevent rotation of said cutting edge in a direction inwardly from said circumference of said disc saw blade, said stop means thereby absorbing rotational forces transmitted from said cutting edge during cutting.

9. A tooth as recited in claim 3, for installation in one of a plurality of arcuate sockets around the circumference of said disc saw blade, wherein said tooth comprises an arcuate body having a tail end and a cutting end, said cutting end having a cutting edge projecting slightly from the circumference of said disc saw blade when said tooth is installed in a said arcuate socket, each said tooth when installed having a portion thereof butting against stop means associated with said disc saw blade to prevent rotation of said cutting edge in a direction inwardly from said circumference of said disc saw blade, said stop means thereby absorbing rotational forces transmitted from said cutting edge during cutting.

10. A tooth as recited in claim 4, for installation in one of a plurality of arcuate sockets around the circumference of said disc saw blade, wherein said tooth comprises an arcuate body having a tail end and a cutting end, said cutting end having a cutting edge projecting slightly from the circumference of said disc saw blade when said tooth is installed in a said arcuate socket, each said tooth when installed having a portion thereof butting against stop means associated with said disc saw blade to prevent rotation of said cutting edge in a direction inwardly from said circumference of said disc saw blade, said stop means thereby absorbing rotational forces transmitted from said cutting edge during cutting.

11. A tooth as recited in claim 5, for installation in one of a plurality of arcuate sockets around the circumference of said disc saw blade, wherein said tooth comprises an arcuate body having a tail end and a cutting end, said cutting end having a cutting edge projecting slightly from the circumference of said disc saw blade when said tooth is installed in a said arcuate socket, each said tooth when installed having a portion thereof butting against stop means associated with said disc saw blade to prevent rotation of said cutting edge in a direction inwardly from said circumference of said disc saw blade, said stop means thereby absorbing rotational forces transmitted from said cutting edge during cutting.

12. A tooth as recited in claim 6, for installation in one of a plurality of arcuate sockets around the circumference of said disc saw blade, wherein said tooth comprises an arcuate body having a tail end and a cutting end, said cutting end having a cutting edge projecting slightly from the circumference of said disc saw blade when said tooth is installed in a said arcuate socket, each said tooth when installed having a portion thereof butting against stop means associated with said disc saw blade to prevent rotation of said cutting edge in a direction inwardly from said circumference of said disc saw blade, said stop means thereby absorbing rotational forces transmitted from said cutting edge during cutting.

13. A tree harvesting disc saw blade, comprising a disc and a plurality of teeth spaced circumferentially around said disc, each said tooth comprising a body having a cutting edge projecting slightly from the circumference of said disc saw, each said tooth having at least one wear-resistant insert having a length extending rearwardly along said tooth from a leading edge thereof, said length being at least twice the thickness of said insert, said insert being of a material which is substantially harder and more wear-resistant than adjacent material of the tooth.

14. A tree harvesting disc saw blade as recited in claim 13, each said tooth comprising at least two said wear-resistant inserts, extending respectively along portions of upper and lower surfaces of said tooth.

15. A tree harvesting disc saw blade as recited in claim 13, each said tooth comprising a said wear-resistant insert extending across the thickness of the tooth on a radially outer surface thereof.

16. A tree harvesting disc saw blade as recited in claim 13, each said tooth comprising a said wear-resistant insert extending across the thickness of the tooth on a radially outer surface thereof, and two said wear-resistant inserts, extending respectively along upper and lower outer surfaces of said tooth.

17. A tree harvesting disc saw blade as recited in claim 15, wherein said wear-resistant insert is curved, upper and lower leading edge portions thereof being ahead of a central leading edge portion.

18. A tree harvesting disc saw blade as recited in claim 16, wherein said wear-resistant insert extending across the thickness of the tooth is curved, upper and lower leading edge portions thereof being ahead of a central leading edge portion.

19. A tree harvesting disc saw blade as recited in claim 13, wherein each said tooth comprises an arcuate body having a tail end and a cutting end, said cutting end having said cutting edge projecting slightly from the circumference of said disc saw blade, each said tooth having a portion thereof butting against stop means associated with said disc saw blade to prevent rotation of said cutting edge in a direction inwardly from said circumference of said disc saw blade, said stop means thereby absorbing rotational forces transmitted from said cutting edge during cutting.

20. A tree harvesting disc saw blade as recited in claim 14, wherein each said tooth comprises an arcuate body having a tail end and a cutting end, said cutting end having said cutting edge projecting slightly from the circumference of said disc saw blade, each said tooth having a portion thereof butting against stop means associated with said disc saw blade to prevent rotation of said cutting edge in a direction inwardly from said circumference of said disc saw blade, said stop means thereby absorbing rotational forces transmitted from said cutting edge during cutting.

21. A tree harvesting disc saw blade as recited in claim 15, wherein each said tooth comprises an arcuate body having a tail end and a cutting end, said cutting end having said cutting edge projecting slightly from the circumference of said disc saw blade, each said tooth having a portion thereof buffing against stop means associated with said disc saw blade to prevent rotation of said cutting edge in a direction inwardly from said circumference of said disc saw blade, said stop means thereby absorbing rotational forces transmitted from said cutting edge during cutting.

22. A tree harvesting disc saw blade as recited in claim 16, wherein each said tooth comprises an arcuate body having a tail end and a cutting end, said cutting end having said cutting edge projecting slightly from the circumference of said disc saw blade, each said tooth having a portion thereof butting against stop means associated with said disc saw blade to prevent rotation of said cutting edge in a direction inwardly from said circumference of said disc saw blade, said stop means thereby absorbing rotational forces transmitted from said cutting edge during cutting.

23. A tree harvesting disc saw blade as recited in claim 17, wherein each said tooth comprises an arcuate body having a tail end and a cutting end, said cutting end having said cutting edge projecting slightly from the circumference of said disc saw blade, each said tooth having a portion thereof butting against stop means associated with said disc saw blade to prevent rotation of said cutting edge in a direction inwardly from said circumference of said disc saw blade, said stop means thereby absorbing rotational forces transmitted from said cutting edge during cutting.

24. A tree harvesting disc saw blade as recited in claim 18, wherein each said tooth comprises an arcuate body having a tail end and a cutting end, said cutting end having said cutting edge projecting slightly from the circumference of said disc saw blade, each said tooth having a portion thereof butting against stop means associated with said disc saw blade to prevent rotation of said cutting edge in a direction inwardly from said circumference of said disc saw blade, said stop means thereby absorbing rotational forces transmitted from said cutting edge during cutting.
